(19) United States
(12) Patent Application Publication
(10) Pub. No.: US 2013/0292467 A1
(43) Pub. Date: Nov. 7, 2013

(54) System and Method for Automatic Visitor Check-In and Access Card Issuance

(71) Applicants: Muthupandian AVS, Madurai (IN); Balamunigan Venkatesan, Madurai (IN)

(72) Inventors: Muthupandian AVS, Madurai (IN); Balamunigan Venkatesan, Madurai (IN)

(73) Assignee: Honeywell International Inc., Morristown, NJ (US)

(21) Appl. No.: 13/462,675

(22) Filed: May 2, 2012

(51) Int. Cl. G06K 5/00

(52) U.S. Cl. 235/381; 235/382

(57) ABSTRACT

A method and apparatus are disclosed for accessing a secure area. The method includes the steps of preregistering a plurality of visitors with an access control system, the access control system receiving a request for a single instance of access to the secure area through a communication system from one of the plurality of preregistered visitors, the requesting preregistered visitor authenticating himself or herself to a kiosk that dispenses access cards, the kiosk dispensing an access control card to the requesting preregistered visitor and the access control system establishing the access control card within the access kiosk based upon the request and dispensing the established access control card in response to authentication of the requesting preregistered visitor.

### FIELD

The field relates to secure areas and to temporary access cards used for admittance into such areas.

### BACKGROUND

The need for establishing and maintaining secure areas are well known. In the case of an enterprise organization, the assets of the organization may be preserved within the secure area.

The secure area is usually surrounded by a physical barrier (e.g., walls, fences, etc.). One or more access ports (e.g., door) may be provided to allow employees of the organization to enter/egress the secure area.

Control must be maintained over the access ports. In some organizations, the control is maintained by posting a guard by the access port where the guard prevents entrance/egress by anyone not familiar to the guard.

In more sophisticated organizations, automatic entrance/egress is provided via an identification card that may be electronically read by a card reader. Often the card reader is connected to a database containing identifiers of authorized persons.

While such systems work well in most cases, they are difficult to administer in cases where large numbers of visitors must enter and leave a secure area. In such cases, a receptionist is provided who greets visitors, identifies the visitor and calls for authorization to admit the visitor from a person familiar with the visitor. Often a pass is issued that provides access to the secure area by the visitor. In some cases, a great deal of time may be lost waiting for passes or contacting the proper person within the organization. Accordingly, a need exists for better methods of controlling temporary access to secure areas.

### BRIEF DESCRIPTION OF THE DRAWINGS

FIG. 1 is a block diagram of a visitor access control system allowing access into a secure area in accordance with an illustrated embodiment; and

FIG. 2 is a flow chart of method steps that may be used by the system of FIG. 1.

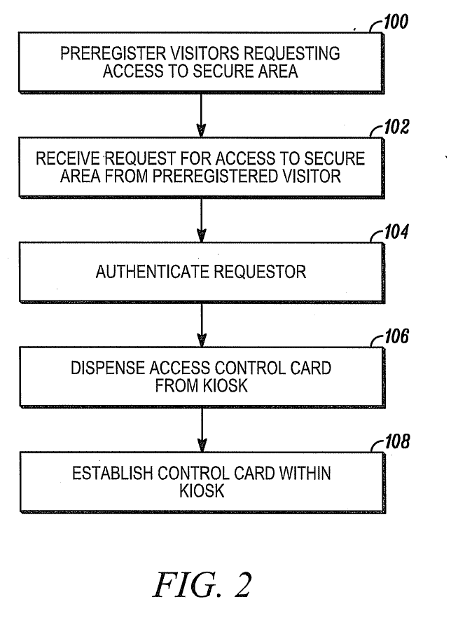

### DETAILED DESCRIPTION OF AN ILLUSTRATED EMBODIMENT

Visitor management activities like card issue/return, visitor check-in/check-out for entry into the secure areas of large organizations are usually done by an operator (e.g., a receptionist) at the reception desk. During peak business hours, when many visitors arrive, visitor management activities (like registering a visitor and issuing a card) can get delayed and cause inconvenience to the visitors and operators at a site. For Example, sites such as a bank may have 1000 visitors or more daily. Managing such huge numbers of visitors requires many operators at a reception area which greatly increases the cost of operation.

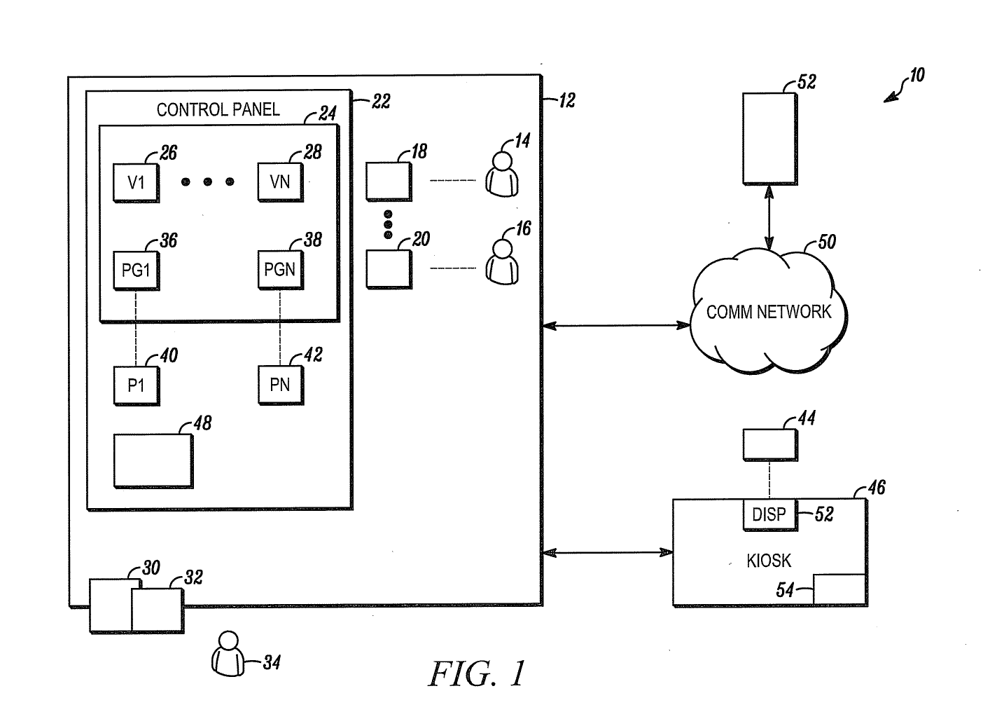

FIG. 1 depicts a security system 10 shown generally in accordance with an illustrated embodiment that provides temporary access by visitors to a secure area 12 of an organization. Included within the secure area may be a control panel 22 of the security system 10 that controls access to the secure area through one or more portals (e.g., doors, turnstiles, etc.) 30 via a user interface device (e.g., a card reader) 32. One or more employees (persons) 14, 16 may interact with a control panel 22 through respective terminal 18, 20 to provide access to visitors 34 through one of the doors 30.

Included within the control panel 22 may be one or more processors 40, 42 (embodied as hardware) that each operate under control of one or more computer programs 36, 38 loaded from a non-transitory computer readable medium (memory) 24. The processors 40, 42 interact with the employees 14, 16 and visitors as discussed in more detail below.

To solve the issue of access to the secure area 12, visitors 34 are preregistered with the security system 10. In the preregistered functionality provided by the system 10, the visitors 34 are registered in memory 24 of the system 10 by the employees 14, 16 through terminals 18, 20. In this case, the employees 14, 16 may register the identity of each visitor 34 by saving identifying information (e.g., name, address, account number, personal identification number (PIN), photograph of the visitor, finger print, iris scan signature, etc.) into a respective preregistration visitor file 26, 28 in memory 24. The information from the file 26, 28 may then be used in conjunction with later requests for access to grant temporary, one-time entry into the secure area 12. For instance, bank customers wanting access to their safe deposit boxes will be asked to fix a particular date and time for their visit. Such visitors will be preregistered and their access rights (door that the user could access and the time frame) could be assigned during the preregistration process or later in response to an access request.

Once preregistered, the visitor 34 submits a request, in advance, for each one-time access into the secure area 12. The visitor 34 may specify a time, a date and a location within the secured area for which access is sought. In the case of a bank, the destination may be a safe deposit box. Alternatively, the destination may be the office of a specific person in a multi-story building.

Pre-registered visitors (who have also previously submitted a request for access), on the day of their visit will receive his/her badge 44 through a visitor management kiosk device 46. The badge 44 may be inexpensively printed on paper using appropriate security features (e.g., bar code, QR code, photograph of the visitor, etc.).

In order to request access, the visitor 34 may first contact a user interface 48 of the system 10 through a public communication network 50 from a remotely located communication device 52. In one particular embodiment, the communication device 52 may be a telephone and the user interface 48 may be an interactive voice response (IVR) unit hosted by an IVR processor 40, 42. In this case, the IVR 48 may provide one or more audio prompts requesting that the caller state a purpose of the call, followed by a request that the caller identify himself or herself by stating a name or account number. The caller may also be asked to identify a day and time for access as well as other information necessary to authenticate the identity of the caller.

Alternatively, the communication device 52 may include a web browser and the user interface 48 may be a website hosted by a website processor 40, 42. In this case, the requester may formulate an access request, including a date and time and authentication information, through an interactive webpage.

In each case, a request processor 40, 42 receives the identifiers and authentication information from the visitor 34 and processes the information accordingly. As a first step, the processor 40, 42 may search memory 24 for a preregistration file 26, 28 with a visitor identifier that matches the request. If a file 26, 28 is identified, the request processor 40, 42 compares the authentication information submitted along with the request with pre-existing authentication information found within the file 26, 28. Upon matching the contents of the access request with a preregistration file 26, 28, an access card 44 for the requesting visitor may be established based upon the access request. The details of the one-time grant of access may also be saved in the corresponding file 26, 28.

The security system 10 may also provide confirmation to the visitor 34 upon acceptance of the request. The confirmation may simply be a receipt that lists the day and time that access is to be provided.

In addition (and depending on the level of security required by) the authentication provided by the requestor, the confirmation may be printed on paper and used as a ticket for obtaining physical possession of the access card 44. For example, the confirmation may be provided as a bar code or QR code printed on the provided confirmation. Alternatively, the security system 10 may provide a randomly generated PIN number provided along with the confirmation that is later used to gain physical access to the access card 44.

In this regard, a content of the matching preregistration file 26, 28 (and content of the submitted request) may be used to define a set of conditions for use of the access card 44. In all cases, the use of the card will be under a one-time format based upon the status of the user as a visitor. One time use may include presentation of the card 44 to one or more card readers 32 and access through one or more doors 30 in such a manner as to allow the visitor reasonable access to some pre-authorized destination within the protected area 12.

Upon establishment of the access card 44, the visitor 34 may proceed to the secured area 12 on the day of the request for access. In this regard, the kiosk 46 may be located outside the secured area 12 or in a reception area of the secured area 12. In order to gain physical access to the card 44, the visitor 34 may first identify himself or herself to the security system 10 through a user interface 54 of the kiosk 46. In this regard, the user may enter his name through a keyboard or select his name from a list of visitors 34 who will be given access on that day.

Upon entry of the visitor's name, an authentication processor 40, 42 may again search the memory 24 for a preregistration file 26, 28 that matches the identification information provided by the visitor 34 through the user interface 54. If a match is found regarding identity, then the authentication processor 40, 42 may request additional information to confirm the identity of the visitor 34. The additional information may be entered through the user interface 54 or through an auxiliary identification device (e.g., bar code or QR code scanner, fingerprint scanner, iris scanner, etc.) associated with the user interface 54.

In this case, the additional information requested from the visitor 34 through the user interface 54 may be different than the information previously provided along with the initial request. For example, the initial request may simply have required a valid name and account number. In this case, the additional information requested through the user interface 54 may be a PIN number or other indicia of identity (e.g., a fingerprint, iris pattern, etc.).

The authentication processor 40, 42 may receive the additional information and compare such information with the content of the appropriate visitor file 26, 28. If a match is found, then the authentication processor 40, 42 may activate a card dispenser 52 to physically dispense the card 44 to the user 34. If the visitor 34 could not be identified or authenticated or had not previously requested access on the day in question, then the authentication processor 40, 42 will deny access. In this case, the visitor 34 may be required to contact the appropriate personnel 14, 16 to request access using prior methods.

Under one illustrated embodiment, identifying information on the card 44 is not correlated with the visitor 34 until the visitor 34 has been authenticated to the system 10 through the user interface 54 of the kiosk 46. In this situation, the display of the user interface 54 displays identifying information of the visitor 34 following authentication of the visitor 34 and the user receives a card from the dispenser 52. The visitor 34 then swipes the card 44 through a reader on the kiosk. Once swiped through the reader on the kiosk 46, identifying information on the card 44 is associated with the identifying information of the visitor 34 within the security system 10. The user is then able to use the card 44 for entry into the secure area 12.

The kiosk 46 may also display instructions of how and where to use the access card 44 to enter the secure area 12. In the case of a secure area with many doors 30, a map may be provided on a display of the user interface 54 that shows the specific location of access. The visitor 34 may then proceed to the proper door 30, swipe his card 44 through the card reader 32 and enter the secured area 12 without any further delay.

In general, the system 10 provides a simplified method and apparatus for providing access to visitors. The method may include the steps of preregistering a plurality of visitors with an access control system, where each of the plurality of visitors is a person desiring physical entry by the person into a secure area of a facility defined by a predetermined geographic area 100, the access control system receiving a request for a single instance of access to the secure area through a communication system from one of the plurality of preregistered visitors 102, the requesting preregistered visitor authenticating himself or herself to a kiosk that dispenses access cards 104, the kiosk dispensing an access control card to the requesting preregistered visitor 106 and the access control system establishing the access control card within the access kiosk based upon the request and dispensing the established access control card in response to authentication of the requesting preregistered visitor, the access control card granting automatic access to the secure area upon presentation of the card by the requesting preregistered visitor to a card reader on a periphery of the secure area 108.

In a similar manner, the apparatus may include a security system having a plurality of visitors preregistered with security system, where each of the plurality of visitors is a person desires physical entry by the person into a secure area of a facility defined by a predetermined geographic area, a publically accessible user interface of the security system, the user interface receives a request for a single instance of access to the secure area from a remote site through a public communication system from one of the plurality of preregistered visitors, a kiosk of the security system, the requesting preregistered visitor authenticating himself or herself to a kiosk that dispenses access cards, the kiosk dispensing an access control card to the requesting preregistered visitor and a processor of the security system, the processor establishes the access control card within the access kiosk based upon the request and dispenses the established access control card in response to authentication of the requesting preregistered visitor, the access control card grants automatic access to the secure area upon presentation of the card by the requesting preregistered visitor to a card reader on a periphery of the secure area.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A method comprising:
preregistering a plurality of visitors with an access control system, where each of the plurality of visitors is a person desiring physical entry by the person into a secure area of a facility defined by a predetermined geographic area;
the access control system receiving a request for a single instance of access to the secure area through a communication system from one of the plurality of preregistered visitors;
the requesting preregistered visitor authenticating himself or herself to a kiosk that dispenses access cards;
the kiosk dispensing an access control card to the requesting preregistered visitor; and
the access control system establishing the access control card within the access kiosk based upon the request and dispensing the established access control card in response to authentication of the requesting preregistered visitor, the access control card granting automatic access to the secure area upon presentation of the card by the requesting preregistered visitor to a card reader on a periphery of the secure area.

2. The method as in claim 1 wherein the authenticating further comprises the requesting preregistered visitor selecting his or her name from a display of the kiosk.

3. The method as in claim 1 wherein the authenticating further comprises the requesting preregistered visitor entering a personal identification number through a keyboard of the kiosk.

4. The method as in claim 1 wherein the authenticating further comprises the requesting preregistered visitor presenting a bar code to a reader of the kiosk.

5. The method as in claim 1 wherein the request further comprises specifying a date for access to the secure area.

6. The method as in claim 1 wherein the request further comprises specifying a date and a time for access to the secure area.

7. The method as in claim 1 wherein the request further comprises specifying a destination within the secure area.

8. The method as in claim 7 further comprising the kiosk displaying a map of the secure area with the destination identified on the map.

9. The method as in claim 7 further comprising the kiosk identifying an access portal for entry into the secure area.

10. An apparatus comprising:
a security system having a plurality of visitors preregistered with security system, where each of the plurality of visitors is a person desires physical entry by the person into a secure area of a facility defined by a predetermined geographic area;
a publically accessible user interface of the security system, the user interface receives a request for a single instance of access to the secure area from a remote site through a public communication system from one of the plurality of preregistered visitors;
a kiosk of the security system, the requesting preregistered visitor authenticating himself or herself to a kiosk that dispenses access cards, the kiosk dispensing an access control card to the requesting preregistered visitor; and
a processor of the security system, the processor establishes the access control card within the access kiosk based upon the request and dispenses the established access control card in response to authentication of the requesting preregistered visitor, the access control card grants automatic access to the secure area upon presentation of the card by the requesting preregistered visitor to a card reader on a periphery of the secure area.

11. The apparatus as in claim 10 wherein the kiosk further comprises a user interface on the kiosk, the requesting preregistered visitor selects his or her name from a display of the kiosk.

12. The apparatus as in claim 10 wherein the kiosk further comprises a keyboard on the kiosk, the requesting preregistered visitor enters a personal identification number through a keyboard of the kiosk.

13. The apparatus as in claim 10 further comprising a bar code, the requesting preregistered visitor presenting a bar code to a reader of the kiosk.

14. The apparatus as in claim 10 wherein the request further comprises a date specified for access to the secure area.

15. The apparatus as in claim 10 wherein the request further comprises a date and a time for access to the secure area.

16. The apparatus as in claim 10 wherein the request further comprises specifying a destination within the secure area.

17. The apparatus as in claim 16 further comprising a map displayed by the kiosk, the map of the secure area shows the destination identified on the map.

18. The apparatus as in claim 16 wherein the map further comprises the destination displayed on the map.

19. A non-transitory machine-readable medium comprising instructions, which when executed by one or more processors, cause the one or more processors to perform the following operations:
preregistering a plurality of visitors with an access control system, where each of the plurality of visitors is a person desiring physical entry by the person into a secure area of a facility defined by a predetermined geographic area;
the access control system receiving a request for a single instance of access to the secure area through a communication system from one of the plurality of preregistered visitors;
the requesting preregistered visitor authenticating himself or herself to a kiosk that dispenses access cards;
the kiosk dispensing an access control card to the requesting preregistered visitor; and
the access control system establishing the access control card within the access kiosk based upon the request and dispensing the established access control card in response to authentication of the requesting preregistered visitor, the access control card granting automatic access to the secure area upon presentation of the card by the requesting preregistered visitor to a card reader on a periphery of the secure area.

20. The system as in claim 19 further comprising the step of the user entering an identifier of the user through a user interface of the kiosk.
